(19) United States
(12) Patent Application Publication
(10) Pub. No.: US 2026/0303188 A1
(43) Pub. Date: Oct. 1, 2026

(54) BEAM SET ADAPTATION FOR BEAM MEASUREMENT

(71) Applicant: LENOVO (BEIJING) LIMITED, Beijing (CN)

(72) Inventors: Yinghao Zhang, Beijing (CN); Jianfeng Wang, Beijing (CN); Bingchao Liu, Beijing (CN)

(21) Appl. No.: 19/489,053

(22) PCT Filed: Jun. 2, 2023
(86) PCT No.: PCT/CN2023/098156

§ 371 Date: Dec. 1, 2025

(51) Int. Cl. H04B 7/06; H04B 17/26; H04W 24/10

(52) U.S. Cl. CPC H04B 7/06952; H04B 17/26; H04W 24/10

(57) ABSTRACT

Embodiments of the present disclosure relate to a solution for adapting a beam set for beam measurement. In an aspect, a terminal device obtains configuration information for performing a beam set change for beam measurement, and determines, based on the configuration information, a second beam set associated with a second RS set based on a first beam set associated with a first RS set. The terminal device further determines, based on the configuration information, whether to perform the beam set change, and transmits, to a network device, indication information of the second RS set based on determining to perform the beam set change. The terminal device further performs the beam measurement based on the second RS set transmitted by the network device. In this way, a better performance in UE reporting overhead can be achieved, and the RS overhead can be reduced.

### FIELD

Embodiments of the present disclosure generally relate to the field of communication, and in particular to a terminal device, a network device, methods, and a non-transitory computer readable medium for adapting a beam set for beam measurement.

### BACKGROUND

An artificial intelligence/machine learning (AI/ML) model on beam management (BM) has been discussed in 3rd generation partnership project (3GPP) work group in terms of spatial beam prediction (BM-case1) and temporal beam prediction (BM-case2). The AI/ML model on beam management can be classified into two categories according to which side maintaining the AI/ML model. One category is network (NW) side AI/ML model, and the other is user equipment (UE) side AI/ML model.

With a UE-side AI/ML model, reference signals (RSs) associated to a special beam set (which is also referred as set B thereafter) with a small number of beams are configured and transmitted by the network device, then the UE performs beam measurement based on the RSs. The measured results are then input into the AI/ML model to infer another beam set (which is also referred as set A thereafter) with a larger number of beams.

### SUMMARY

In general, embodiments of the present disclosure provide a solution for adapting or changing a beam set for beam measurement. With the embodiment of the present disclosure, the overhead of the RS associated to the beam set can be reduced further with no impact or accepted impacts on the measurement results.

In a first aspect, there is provided a terminal device. The terminal device comprises a processor and a transceiver coupled to the processor. The processor is configured to obtain configuration information for performing a beam set change for beam measurement. The processor is further configured to determine, based on the configuration information, a second beam set associated with a second reference signal (RS) set based on a first beam set associated with a first RS set. The processor is further configured to determine, based on the configuration information, whether to perform the beam set change. The processor is further configured to, based on determining to perform the beam set change, transmit, via the transceiver to a network device, indication information of the second RS set. The processor is further configured to perform, via the transceiver, the beam measurement based on the second RS set transmitted by the network device.

In a second aspect, there is provided a network device. The network device comprises a processor and a transceiver coupled to the processor. The processor is configured to obtain configuration information for a terminal device to perform a beam set change for beam measurement. The processor is further configured to receive, via the transceiver from the terminal device, indication information of a second reference signal (RS) set associated with a second RS set, wherein a second beam set is determined based on a first beam set associated with a first RS set based on the configuration information. The processor is further configured to transmit, via the transceiver to the terminal device, the second RS set for the beam measurement.

In a third aspect, there is provided a method performed by a terminal device. The method comprises obtaining configuration information for performing a beam set change for beam measurement. The method further comprises determining, based on the configuration information, a second beam set associated with a second reference signal (RS) set based on a first beam set associated with a first RS set. The method further comprises determining, based on the configuration information, whether to perform the beam set change. The method further comprises based on determining to perform the beam set change, transmitting, via the transceiver to a network device, indication information of the second RS set. The method further comprises performing, via the transceiver, the beam measurement based on the second RS set transmitted by the network device.

In a fourth aspect, there is provided a method performed by a network device. The method comprises obtaining configuration information for a terminal device to perform a beam set change for beam measurement. The method further comprises receiving, via the transceiver from the terminal device, indication information of a second reference signal (RS) set associated with a second RS set, wherein a second beam set is determined based on a first beam set associated with a first RS set based on the configuration information. The method comprises transmitting, via the transceiver to the terminal device, the second RS set for the beam measurement.

In a fifth aspect, there is provided a non-transitory computer readable medium. The non-transitory computer readable medium having program instructions stored thereon. The program instructions, when executed by an apparatus, causing the apparatus to perform at least the methods of the third aspect or the fourth aspect.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some embodiments will now be described with reference to the accompanying drawings, in which:

FIG. 1 illustrates a schematic diagram of a communication environment in which some embodiments of the present disclosure can be implemented;

FIG. 2 illustrates an example signaling process for determining a beam set for beam measurement according to some embodiments of the present disclosure;

FIG. 3 illustrates an example illustration for an interleaved transmission of RSs for Set B and RSs for Set C according to some embodiments of the present disclosure;

FIGS. 4A-4D illustrate some examples of illustrations of RS patterns according to some embodiments of the present disclosure;

FIG. 5 illustrates a flowchart of an example method for determining a beam set for beam measurement according to some other embodiments of the present disclosure;

FIG. 6 illustrates another flowchart of an example method for determining a beam set for beam measurement according to some other embodiments of the present disclosure; and

FIG. 7 illustrates a simplified block diagram of a device that is suitable for implementing embodiments of the present disclosure.

Throughout the drawings, the same or similar reference numerals represent the same or similar elements.

### DETAILED DESCRIPTION

Principles of the present disclosure will now be described with reference to some embodiments. It is to be understood that these embodiments are described only for the purpose of illustration and help those skilled in the art to understand and implement the present disclosure, without suggesting any limitation as to the scope of the disclosure. The disclosure described herein may be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an example embodiment,” “an embodiment,” “some embodiments,” and the like indicate that the embodiment(s) described may include a particular feature, structure, or characteristic, but it is not necessary that every embodiment includes the particular feature, structure, or characteristic. Moreover, such phrases do not necessarily refer to the same embodiment(s). Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” or the like may be used herein to describe various elements, these elements should not be limited by these terms. These terms are only used to distinguish one element from another element. For example, a first element could also be termed as a second element, and similarly, a second element could also be termed as a first element, without departing from the scope of embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used herein, the term “communication network” refers to a network following any suitable communication standards, such as, 5G NR, Long Term Evolution (LTE), LTE-Advanced (LTE-A), Wideband Code Division Multiple Access (WCDMA), High-Speed Packet Access (HSPA), Narrow Band Internet of Things (NB-IoT), and so on. Further, the communications between a terminal device and a network device in the communication network may be performed according to any suitable generation communication protocols, including but not limited to, the first generation (1G), the second generation (2G), 2.5G, 2.75G, the third generation (3G), the fourth generation (4G), 4.5G, the fifth generation (5G) communication protocols, and/or any other protocols either currently known or to be developed in the future. Embodiments of the present disclosure may be applied in various communication systems. Given the rapid development in communications, there will also be future type communication technologies and systems in which the present disclosure may be embodied. It should not be seen as limiting the scope of the present disclosure to only the aforementioned systems.

As used herein, the term “network device” generally refers to a node in a communication network via which a terminal device can access the communication network and receive services therefrom. The network device may refer to a base station (BS) or an access point (AP), for example, a node B (NodeB or NB), a radio access network (RAN) node, an evolved NodeB (eNodeB or eNB), a NR NB (also referred to as a gNB), a Remote Radio Unit (RRU), a radio header (RH), an infrastructure device for a V2X (vehicle-to-everything) communication, a transmission and reception point (TRP), a reception point (RP), a remote radio head (RRH), a relay, an integrated access and backhaul (IAB) node, a low power node such as a femto BS, a pico BS, and so forth, depending on the applied terminology and technology.

As used herein, the term “terminal device” generally refers to any end device that may be capable of wireless communications. By way of example rather than a limitation, a terminal device may also be referred to as a communication device, a user equipment (UE), an end user device, a subscriber station (SS), an unmanned aerial vehicle (UAV), a portable subscriber station, a mobile station (MS), or an access terminal (AT). The terminal device may include, but is not limited to, a mobile phone, a cellular phone, a smart phone, a voice over IP (VOIP) phone, a wireless local loop phone, a tablet, a wearable terminal device, a personal digital assistant (PDA), a portable computer, a desktop computer, an image capture terminal device such as a digital camera, a gaming terminal device, a music storage and in playback appliance, a vehicle-mounted wireless terminal device, a wireless endpoint, a mobile station, laptop-embedded equipment (LEE), laptop-mounted equipment (LME), a USB dongle, a smart device, wireless customer-premises equipment (CPE), an Internet of Things (IoT) device, a watch or other wearable, a head-mounted display (HMD), a vehicle, a drone, a medical device (for example, a remote surgery device), an industrial device (for example, a robot and/or other wireless devices operating in an industrial and/or an automated processing chain contexts), a consumer electronics device, a device operating on commercial and/or industrial wireless networks, and the like. In the following description, the terms: “terminal device,” “communication device,” “terminal,” “user equipment” and “UE,” may be used interchangeably.

As used herein, the term “resource,” “transmission resource,” “resource block,” “physical resource block,” “uplink resource,” “downlink resource,” or “sidelink resource” may refer to any resource, for example a resource in time domain, a resource in frequency domain, a resource in space domain, a resource in code domain, or any other resource enabling a communication, and the like, used for performing a communication between a terminal device and a network device or between terminal devices. In the following, a resource in both frequency and time domain will be used as an example of a transmission resource for describing some embodiments of the present disclosure. It is noted that embodiments of the present disclosure equally apply to other resources in other domains.

As mentioned above, with the UE-side AI/ML model, RSs associated to Set B are configured and transmitted by the network device. Using the UE side AI/ML model can avoid huge UE report overhead for beam measurement compared to using NW side AI/ML model. However, the gNB RS overhead for beams within Set B is still there. Evaluation results show that the larger size of Set B, the greater beam prediction performance. Thus, it requires more gNB RS overhead.

In RANI work group, topics of evaluation on AI/ML for beam management and other aspects on AI/ML for beam management have been discussed. In topic of evaluation on AI/ML for beam management, an agreement has been made. The agreement comes from the observation of entities that reporting measurement of a subset of measurement beams can reduce UE reporting overhead with minor performance loss for NW side AI/ML model.

In view of the above, some embodiments of the present disclosure propose a solution for determining a beam set for beam measurement. For example, the terminal device may determine a RS pattern associated to a beam set (which is also referred as Set C) based on the relevant information. The terminal device may decide to perform measurement set adaptation based on the relevant configuration. The relevant configuration may be configured by the network device. The terminal device may report the RS pattern associated to Set C to the network device. The network device may configure the UE of RS resource based on the reported RS pattern, and network device may perform interleaved transmission of RSs for Set B and RSs for Set C.

It is to be noted that, as used herein, the RS pattern may indicate whether an RS in a RS set exists in another RS set, where each RS in the RS set may correspond to a beam. For example, the RS pattern corresponding to Set C may indicate which RSs in the RS set corresponding to Set B exist in the RS set corresponding to Set C. That is, the RS pattern indicates which beams in Set B exist in Set C.

In this way, a better performance in UE reporting overhead compared to traditional method can be achieved. For example, the RS overhead can be reduced further while the beam prediction accuracy can be maintained. Principles and embodiments of the present disclosure will be described in detail below with reference to the accompanying drawings.

### Example Environment

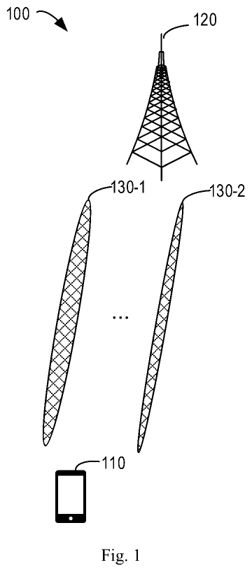

FIG. 1 illustrates an example communication environment 100 in which example embodiments of the present disclosure may be implemented. The communication environment 100, which may be a part of a communication network, includes a terminal device and a network device.

As illustrated in FIG. 1, the communication environment 100 may comprise a terminal device 110 and a network device 120. The terminal device 110 may also be referred as a user equipment 110 or a UE 110. The network device 120 may also be referred as a gNB 120. The network device 120 may communicate with the terminal device 110. The communication environment 100 may comprise a plurality of RSs, for example, RSs 130-1 and 130-2 (or may be collectively referred as RS set 130).

The network device 120 may transmit reference signal set 130 to the terminal device 110. The RS set 130 may be associated with a beam set. It is to be understood that there can be a plurality of reference signals in the RS set 130. The terminal device 110 may receive the RS set 130-1 in the RS resources and perform beam measurement against the received RS set 130. The terminal device 110 may determine a subset of set B (which is referred as Set C) based on the beam measurement. The terminal device 120 may transmit a report of Set C (such as a RS pattern) to the network device 120. The network device 120 may update RS set 130-2 with Set C. The network device 120 may transmit updated RS set 130 associated with Set C (i.e. 130-2) to the terminal device 110.

It is to be understood that the number of terminal devices and/or network devices is given only for the purpose of illustration without suggesting any limitations. The communication environment 100 may include any suitable number of network devices and/or terminal devices adapted for implementing embodiments of the present disclosure.

Communications in the communication environment 100 may be implemented according to any proper communication protocol(s), comprising, but not limited to, the third generation (3G), the fourth generation (4G), the fifth generation (5G), 5G-Advanced or beyond (6G), wireless local network communication protocols such as institute for electrical and electronics engineers (IEEE) 802.11 and the like, and/or any other protocols currently known or to be developed in the future. Moreover, the communication may utilize any proper wireless communication technology, comprising but not limited to: orthogonal frequency division multiplexing (OFDM), time division multiplexing (TDM), frequency division multiplexing (FDM), code division multiplexing (CDM), spatial division multiplexing (SDM) by means of beam-forming or multiple-input multiple-output (MIMO) transmission, carrier aggregation (CA), dual connectivity (DC), new radio unlicensed (NR-U) communication, Bluetooth, ZigBee, etc. The communication may be of any type, comprising but not limited to: machine type communication (MTC), enhanced mobile broadband (eMBB), massive machine type communication (mMTC), ultra-reliable low latency communication (URLLC), etc.

### Example Communication Process

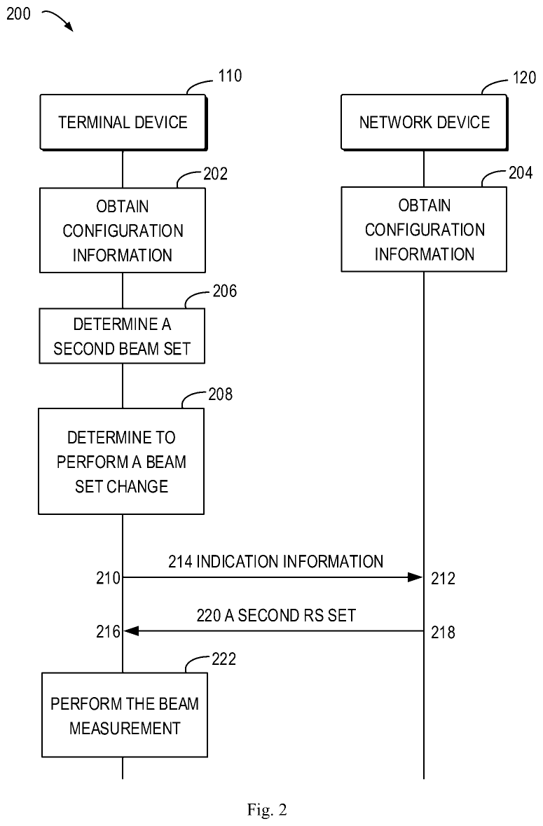

FIG. 2 illustrates an example signaling process 200 for determining a beam set for beam measurement according to some embodiments of the present disclosure. For the purpose of discussion, the signaling process 200 will be described with reference to FIG. 1. It would be appreciated that although the signaling process 200 has been described in the communication environment 100 of FIG. 1, this signaling process 200 may be likewise applied to other communication scenarios.

The network device 120 may indicate the terminal device 110 an AI/ML model by functionality ID or model ID for a beam report configuration. The Set B may be determined as inputted measurement set of the AI/ML model, and the Set A may be determined as outputted set of the AI/ML model. Hence, Set B is a subset of Set A.

As shown in FIG. 2, the terminal device 110 obtains (202) configuration information for performing a beam set change for beam measurement. For example, the terminal device 110 may determine the configuration information. For another example, the terminal device 110 may receive the configuration information from the network device 120. For example, the terminal device 110 may determine the configuration information by itself. The terminal device 110 may transmit the configuration information to the network device 120.

The network device 120 obtains (204) configuration information for performing a beam set change for beam measurement. For example, the network device 120 may determine the configuration information by itself. The network device 120 may transmit the configuration information to the terminal device 110.

The terminal device 110 determines (206) a second beam set (also referred to Set C hereafter) associated with a second reference signal (RS) set based on a first beam set (also referred as Set B thereafter) associated with a first RS set.

In some example embodiments, the network device 120 may configure the terminal device 110 with Set A for beam prediction. The network device 120 may configure the terminal device 110 with Set B for beam measurement. Hence, both the terminal device 110 and the network device 120 know Set B.

In some example embodiments, the terminal device 110 may select a subset from the first beam set. As an example, the network device 120 and the terminal device 110 may align configuration related to measurement set adaptation. The configuration may include at least one of the following: a RS resource set associated with Set B, a RS resource set associated with Set C, a range of N used to determine Set C (N is an integer, e.g., the top-N beams of Set B), a performance loss threshold used to judge a performance of measurement set adaptation, and a resource used to report a RS pattern (such as via UCI, MAC CE or RRC). The range of N may be a single value of N.

If N is not configured, a plurality of beams for Set C may be determined by the terminal device 110, such as by a UE implementation. One UE implementation may be option 1. In option 1, the network device may determine the configuration related to measurement set adaptation, and the network device may configure the terminal device 110 with the configuration related to measurement set adaptation. Another UE implementation may be option 2. In option 2: the terminal device 110 may determine the configuration related to measurement set adaptation, and the terminal device 110 may report it to the network device 120. In some example embodiments, the network device 120 may configure parameters related to the measurement set adaptation.

In some example embodiments, the terminal device 110 may determine a first number of beams with beam widths broader than beams in the first beam set, and a beam in second beam set is related to at least one beam in the first beam set in a second number of measurement instances for the first beam set. For example, there is a spatial mapping between beams in the second beam set and at least one beam in the first beam set. For example, the beams in the second beam set can cover at least one beam in the first beam set in space. In some example embodiments, the network device 120 may activate measurement set adaptation, such as through L1/L2 signaling DCI or MAC CE.

The terminal device 110 determines (208) whether to perform a beam set change. For example, the terminal device 110 may identify whether the effect of measurement adaptation on beam prediction performance is acceptable or not based on configuration related to measurement set adaptation. If acceptable, the terminal device may report to the network device 120 the RS pattern corresponding to Set C.

For example, the terminal device 110 may determine the Set C to be a set consisting of the N strongest beams in the most recent M (where M>=1) Set B measurements. N may be selected from the range of N. In some examples, beams within Set C may be determined by a UE implementation.

As an example, the terminal device 110 may take the average measured L1-RSRP of each beams over M measurement instance to select the top-N beams for M>1. As another example, the beam measurements over M measurement instance may be sorted together with a time-related weight factor and the terminal device 100 may take the first N beam from sorted beams.

The terminal device 110 may calculate the difference of beam prediction performance of using Set C and using Set B, respectively. Then the terminal device 110 may compare the performance difference with the performance loss threshold. The Performance loss may be comprise: the predicted L1-RSRP difference between predicted beam using Set C and predicted beam using Set B, and the number or ratio of different beams among K predicted beams using Set C and K predicted beams using Set B, where K is an integer. The terminal device 129 may determine to perform measurement set adaptation and may report the RS pattern corresponding to Set C to the network device if the difference of beam prediction performance is lower than the threshold.

If the terminal device 110 determines to perform the beam set change, the terminal device 110 transmits (210) indication information 214 of the second RS set to the network device 120. For example, the terminal device 110 may transmit the RS pattern corresponding to Set C of the second RS set to the network device 120.

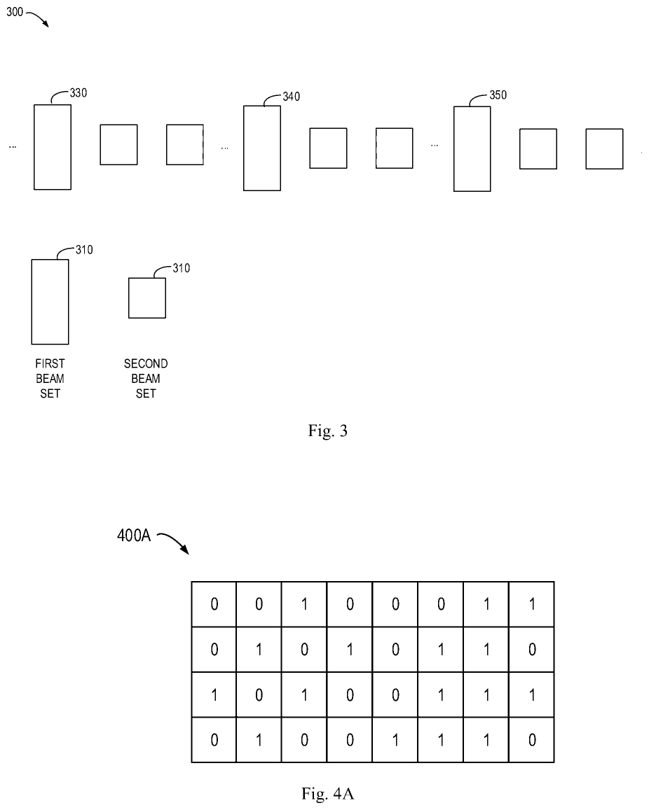

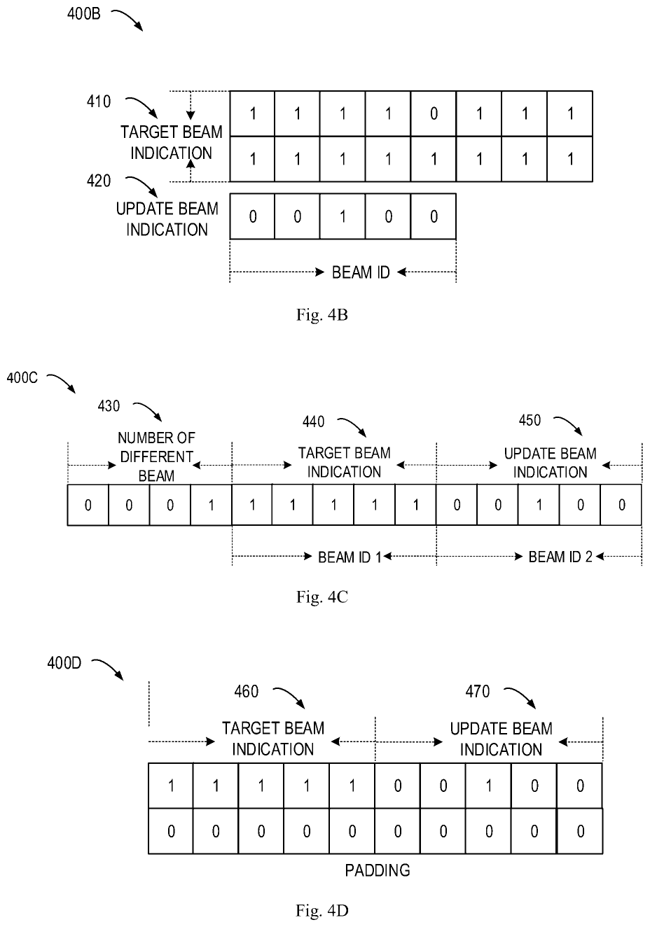

In some example embodiments, the RS pattern corresponding to Set C may be reported through at least one of the following reporting types: a CRI/SSB-RI based reporting, a bitmap based reporting and a UE reporting method of RS pattern for measurement set adaptation. The details of the UE reporting method of RS pattern for measurement set adaptation will be discussed with FIG. 3 to FIG. 4D and for brevity it will not be discussed here.

The network device 120 receives (212) the indication information 214 from the terminal device 110. The network device 120 transmits (218) a second RS set 220 for the beam measurement to the terminal device 110. The terminal device 110 receives (216) the second RS set 220. The terminal device 110 performs (222) the beam measurement based on the second RS set 220 transmitted by the network device 120.

By implementing the signaling process 200, a better performance in UE reporting overhead compared to traditional method can be achieved. For example, the RS overhead can be reduced and the beam prediction accuracy can be maintained.

Reference is made to FIG. 3, which illustrates an example illustration 300 for an interleaved transmission of RSs for Set B and RSs for Set C according to some embodiments of the present disclosure. As shown in FIG. 3, the legend 310 represents the first beam set (Set B). The legend 320 represents the second beam set (Set C). Set B is transmitted at 330, 340 and 350. Set C is transmitted between 330 and 340, or between 340 and 350, and so on.

The network device 120 may configure or activate at least one of RS resources for Set C and RS resources for Set B based on the reported RS pattern. The network device 120 may transmit RSs with the RS resources for Set C until next Set B transmission. The next Set B transmission could be determined based on one or more of following options A to option D.

In option A, at least one of different RS resource periodicities and different offsets are configured. One example may be that the network device 120 may configure semi-persistent RS resources for Set B and Set C, respectively. The RS resource periodicity for Set B may be X times of that for Set C (X is an integer), so that the network device 120 may transmit RSs for Set B once for every X times RSs for Set C.

In option B, an application time for Set C is configured. For example, the network device 120 may configure the application time for Set C. A timer may be set to the application time for Set C. The timer can be started after the first RS transmission for Set C starts; if the timer is expired, the network fallback to RS transmission for Set B and UE receives RSs at the RS resources associated with Set B.

In option C, the terminal device 110 may request RS resources associated to Set C or Set B. The terminal device 110 may signal to request RS resources associated to Set C. The network device 120 may configure or trigger an aperiodic RS resources associated to Set C by DCI. In option D, any two of the above options A, B and C may be combined.

Reference is made to FIG. 4A, which illustrates an example of bitmap 400A of RS patterns according to some embodiments of the present disclosure. As shown in FIG. 4A, “1” in the bitmap 400A represents that corresponding beam belongs to Set C, and “0” in the bitmap 400A represents that corresponding beam does not belong to Set C. Bitmap 400A will be used for the first Set B transmission or upon Set B is updated.

Applying the method for determining a beam set for beam measurement can reduce gNB RS overhead, but also it brings up some UE reporting overhead because of reporting RS pattern. Assuming Set B contains 32 beams and Set C consists of the 16 strongest beams in the most recent a Set B measurement. With CRI/SSB-RI based reporting, RS pattern reporting has 5*16=80 bits overhead. With bitmap based reporting, RS pattern reporting still have 32 bits overhead.

Aiming to the question mentioned above, a UE reporting method of RS pattern for measurement set adaptation is proposed to reduce overhead of RS pattern report. At high level, the terminal device 110 may report the difference information between current RS pattern with last reported RS pattern to implicitly inform the current RS pattern to the network device 120. The detailed difference information is determined based on different configurations.

Reference is made to FIG. 4B, which illustrates another example of bitmap 400B of RS patterns according to some embodiments of the present disclosure. The network device 120 and the terminal device 110 may align configuration related to the difference information, for example, the maximum number of different beams.

The terminal device may determine the difference information between current RS pattern with last reported RS pattern. The difference information between current RS pattern with last reported RS pattern includes that target beam indication and update beam indication. The target beam indication indicates the different beams and same beams between the current RS pattern and last reported RS pattern through the “0” within bitmap and the “1” within bitmap respectively; the update beam indication indicates the beam(s) to replace the different beams through beam ID.

For example, in the target beam indication 410, one beam with “0” is going to be replaced. In the update beam indication 420, a beam with beam ID “00100” is to going to replace the beam with “0” in the target beam indication 410.

In some example embodiments, the bit length of update beam indication 420 may be determined by the target beam indication 410.for example, if the target beam indication 410 indicates y (y is an integer) different beams, then the bit length of update beam indication 420 may have a bit length of y beam IDs.

In some example embodiments, the bit length of update beam indication 420 may be determined by gNB configuration. For example, the gNB 120 may configure the maximum number of different beams, the bit length of update beam indication 420 may be determined as product of maximum number of different beams and bit length of each beam ID. If the number of different beams is less than the maximum number of different beam, zero are padded.

Reference is made to FIG. 4C, which illustrates yet another example of illustration 400C of RS patterns according to some embodiments of the present disclosure. The difference information between the current RS pattern with the last reported RS pattern may include number of different beam indication, target beam indication and update beam indication. The number of different beam indication may indicate number of different beam between beams within current RS pattern with beams within last reported RS pattern. The target beam indication may indicate that different beams between beams within current RS pattern with beams within last reported RS pattern through beam IDs. The update beam indication may indicate the beams to replace the different beams through beam IDs.

For example, as shown in FIG. 4C, the number of different beam indication 430 in illustration 400C is “0001”. This is a binary number, which represents there is one different beam. The target beam indication 440 in illustration 400C represents a beam to be replaced, and its beam ID is “11111”. The update beam indication 450 in illustration 400C represents a beam to replace the beam with beam ID 11111, and this updated beam's beam ID is “00100”.

In some example embodiments, the bit length of update beam indication 450 may be determined by the number of different beam indication 430. The bit length of update beam indication 450 is product of number of different beam and bit length of two beam IDs.

Reference is made to FIG. 4D, which illustrates a further yet another example of bitmap 400D of RS patterns according to some embodiments of the present disclosure. In FIG. 4D, the bit length of update beam indication 450 may be determined by gNB configuration. For example, the gNB 120 may configure the maximum number of different beam. The bit length of update beam indication 450 may be determined as product of maximum number of different beam and bit length of two beam IDs. If the number of different beams is less than the maximum number of different beams, zero are padded.

For example, as shown in FIG. 4D, the maximum number of different beams is two. The first row represents the first different beam, and the second row represents the second different beam. For the first row, the target beam indication 460 may indicate that a beam with beam ID “11111” is going to be replaced, and the update beam indication 470 may indicate that a beam with beam ID “00100” is going to replace the beam as indicated in the target beam indication 460. For the second row, the target beam indication 460 and the update beam indication 470 are padded with zero. This means there is no second different beam.

In some example embodiments, the terminal device 110 may judge whether to report the difference information based on the configuration related to the difference information. If number of different beam between beams within current RS pattern with beams within last reported RS pattern is not larger than the maximum number of different beam, the UE 110 may report the different information. If number of different beam between beams within current RS pattern with beams within last reported RS pattern is larger than the maximum number of different beam, the UE 110 may not report the different information. The RS pattern may be reported through other method, for example, bitmap based reporting.

In some example embodiments, the network device 120 may receive the difference information between current RS pattern with last reported RS pattern and the network device 120 may determine the RS pattern. On the top of this, the network device 120 may determine the RS pattern for Set C and update the Set C or Set B configuration or indication for a beam report configuration, for example, via MAC CE.

In some example embodiments, the network device 120 may determine the RS pattern based on the target beam indication and the update beam indication. In some example embodiments, the network device 120 may determine the RS pattern based on the number of different beam, the target beam indication and the update beam indication.

A simulation regarding the proposed solution for determining a beam set for beam measurement has been done. The performance of baseline and the enhanced scheme (the proposed solution) have been evaluated and compared for verifying the benefits of the enhance schemed. In the simulation, a baseline represents that a gNB transmits RSs for all beams within Set B, and Set B contains 32 beams. The enhanced scheme represents the gNB transmits RSs for top N beams based on previous Set B measurement, and Set B contains 32 beams. The top-N beams within Set B are input to an AI/ML model for model inference with special pre-processing. It is to be noted that the preprocessing means setting the measurement of beams other than the top-N beam in Set B to the minimum value within the top-N beam measurement when inputting data into the AI/ML model during model inference.

In the simulation, the KPIs include RS overhead reduction and beam prediction accuracy where the former is calculated through a ratio of full Set B and a value of N, and the latter is obtained through performing simulation using the AI/ML model for beam prediction. The simulation results are shown in Table 1.

TABLE 1

| | | Adaptation parameter | | RS overhead | Beam prediction accuracy | | |
|---|---|---|---|---|---|---|---|
| Case | Description | Ratio of full Set B | N | reduction | Top1/1 | Top3/1 | Top5/1 |
| Baseline | All 32beams of Set B | 1 | NA | 0 | 80.59% | 96.4% | 98.26% |
| Enhanced | Adaptation Set B | 1/2 | 24 | 12.5% | 78.02% | 95.77% | 98.11% |
| scheme | | 1/2 | 20 | 18.75% | 75.41% | 94.27% | 97.33% |
| | | 1/2 | 16 | 25% | 71.26% | 92.12% | 95.55% |
| | | 1/4 | 24 | 18.75% | 76.79% | 95.43% | 97.99% |
| | | 1/4 | 16 | 37.5% | 66.91% | 90.09 | 94.25% |

As shown in Table 1, when the ratio of full Set B is ½ and the value of N is 24, 12.5% RS overhead reduction can be achieved by the enhanced scheme with ~2% loss in top 1/1 beam prediction accuracy.

Increasing or decreasing the ratio of full Set B and the value of N, the RS overhead reduction and beam prediction accuracy show different trends. Decreasing the ratio of full Set B and/or the value of N, the RS overhead reduction increases and the beam prediction accuracy decreases. Increasing the ratio of full Set B and/or the value of N, the RS overhead reduction decreases and the beam prediction accuracy increases. Based on the observation, the trade-off between RS overhead reduction with beam prediction accuracy can be reached through gNB configuring proper ratio of Set B and value of N. The ratio of Set B and value of N in our invention is controlled by next Set B transmission and N parameters configured by NW.

In the simulation, it is analyzed that the beam data generated by system simulation with agreed scenario or setting and observed the mean number of different beam between with two adjacent reported RS patterns is 0.8. Based on the observation, the proposed RS pattern reporting solution can emulate the UE reporting overhead for RS pattern.

Assuming Set B contains 32 beams and Set C consists of top-16 beams within Set B. In the simulation, for CRI/SSB-RI, UE reporting overhead for RS pattern is 5*16=80 bits, and bitmap is 32 bits. In Option 1 in the simulation, UE reporting overhead for RS pattern is 16+5*0.8=~20 bits. In Option 2 in the simulation, UE reporting overhead for RS pattern is 4+(5+5)*0.8=~12 bits. It can be seen that the proposed RS pattern reporting method has better performance in UE reporting overhead compared to CRI/SSB-RI based method and bitmap based method.

### Example Method

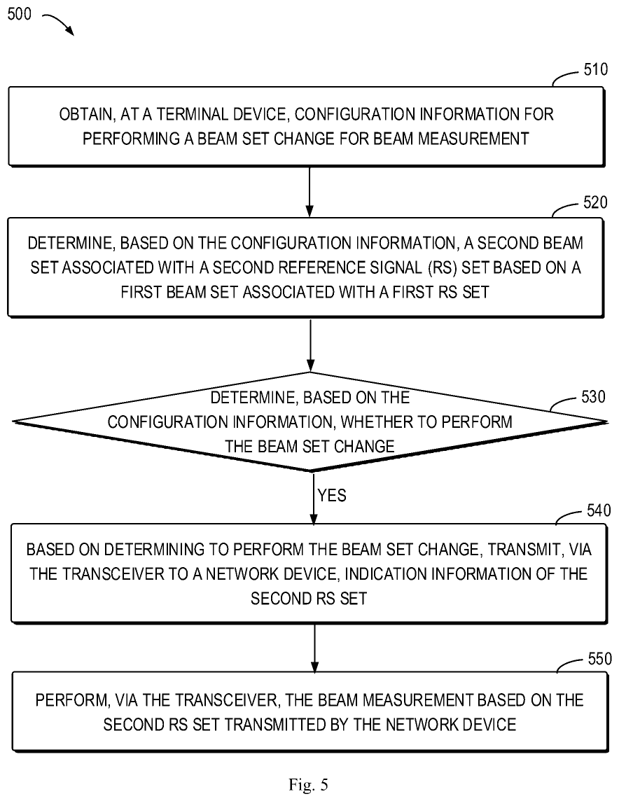

FIG. 5 illustrates a flowchart of an example method 500 for determining a beam set for beam measurement according to some other embodiments of the present disclosure. As shown in FIG. 5, at block 510, the terminal device 110 obtains configuration information for performing a beam set change for beam measurement.

At block 520, the terminal device 110 determines a second beam set associated with a second RS set based on a first beam set associated with a first RS set based on the configuration information. At block 530, the terminal device 110 determines whether to perform the beam set change, based on the configuration information.

At block 540, the terminal device 110 transmits, via the transceiver to a network device 120, indication information of the second RS set based on determining to perform the beam set change. At block 550, the terminal device 110 performs, via the transceiver, the beam measurement based on the second RS set transmitted by the network device 120.

In some example embodiments, the second RS set may be a subset of the first RS set. In some example embodiments, a size of the second RS set is less than a size of the first RS set. In some example embodiments, the terminal device 110 may obtain the configuration information by one of the following: receiving, via the transceiver, the configuration information from the network device 120, or determining the configuration information at the terminal device 110.

In some example embodiments, after determining the configuration information at the terminal device 110, the terminal device 110 may transmit, via the transceiver, the configuration information to the network device 120. In some example embodiments, the second beam set may be determined further based on historical measurement information associated with the first beam set.

In some example embodiments, the second beam set may include a first number of beams in the first beam set, and RS received performance associated with the first number of beams may be better than RS received performance associated with other beams in the first beam set in a second number of measurement instances for the first beam set.

In some example embodiments, the second beam set may include a first number of beams with beam widths broader than beams in the first beam set, and a beam in second beam set may be related to at least one beam in the first beam set in a second number of measurement instances for the first beam set.

In some example embodiments, the first number may be determined based on a first single value or a first value range configured in the configuration information. In some example embodiments, the second number may be determined based on a second single value or a second value range configured in the configuration information.

In some example embodiments, the terminal device 110 may determine whether to perform the beam set change by: determining whether a difference in beam prediction performance between using the first beam set and using the second beam set is below or above a threshold configured in the configuration information, and based on determining that the difference is below the threshold, determining to perform the beam set change, and based on determining that the difference is above the threshold, determining not to perform the beam set change.

In some example embodiments, the difference in the beam prediction performance may comprise one of the following: a layer 1 reference signal received power (L1-RSRP) difference between at least one beam predicted using the first beam set and at least one beam predicted using the second beam set, or a number or ratio of at least one same beam among at least one beam predicted using the first beam set and at least one beam predicted using the second beam set.

In some example embodiments, the terminal device 110 may, based on determining not to perform the beam set change, perform, via the transceiver, the beam measurement based on the first RS set transmitted by the network device 120. In some example embodiments, the first RS set and the second RS set may be transmitted in an interleaving manner.

In some example embodiments, a first set of period RS resource or semi-persistent RS resources with at least one of a first RS resource periodicity and a first offset may be configured by the network device 120 for the first beam set. In some example embodiments, a second set of period RS resource or semi-persistent RS resources with at least one of a second RS resource periodicity and a second offset may be configured by the network device 120 for the second beam set. In some example embodiments, the first RS resource periodicity may be greater than or equal to the second RS resource periodicity, and the first offset and the second offset may have a same or different value.

In some example embodiments, the first RS resource periodicity may be a multiple of the second RS resource periodicity. In some example embodiments, the terminal device 110 may receive, via the transceiver from the network device 120, a time period for performing the beam measurement based on the second beam set. The terminal device 110 may start a timer with the time period when performing the beam measurement based on the second beam set. The terminal device 110 may, in case of expiry of the timer, perform, via the transceiver, the beam measurement based on the first RS set transmitted by the network device 120.

In some example embodiments, the terminal device 110 may, prior to performing the beam measurement based on the second RS set, transmit, via the transceiver to the network device 120, a request for a set of aperiodic RS resources associated with the second RS set, and the terminal device 110 may receive, via the transceiver from the network device 120, downlink control information (DCI) indicative of the set of aperiodic RS resources.

In some example embodiments, the indication information may be reported to the network device 120 using one of: a channel state information reference signal resource indicator (CRI), a synchronization signal and physical broadcast channel block resource indicator (SSB-RI), or a bitmap.

In some example embodiments, the indication information may be indicative of difference information between a first RS pattern to be reported to the network device 120 and a second RS pattern previously reported to the network device 120.

In some example embodiments, the difference information may comprise a first indication indicative of at least one different beam between the first RS pattern and the second RS pattern through a bitmap, and a second indication indicative of at least one beam to replace the at least one different beam through at least one beam identifier.

In some example embodiments, a bit length of the second indication may be determined based on one of the following: the least one different beam indicated by the first indication, or a configuration from the network device 120.

In some example embodiments, the difference information may comprise a first indication indicative of a number of different beams between the first RS pattern and the second RS pattern. The difference information may further comprise a second indication indicative of at least one different beam between the first RS pattern and the second RS pattern through at least one beam identifier. The difference information may further comprise a third indication indicative of at least one beam to replace the at least one different beam through at least one beam identifier.

In some example embodiments, a bit length of at least one of the second indication and the third indication may be determined based on one of the following: the number of different beams indicated by the first indication, or a configuration from the network device 120.

In some example embodiments, the difference information may comprise a second indication indicative of at least one different beam between the first RS pattern and the second RS pattern through at least one beam identifier. The difference information may further comprise a third indication indicative of at least one beam to replace the at least one different beam through at least one beam identifier. In some example embodiments, a bit length of at least one of the second indication and the third indication may be determined based on a configuration of a maximum number of different beams received from the network device 120.

In some example embodiments, the terminal device 110 may transmit the indication information of the second RS set by: determining a number of different beams between a first RS pattern to be reported to the network device 120 and a second RS pattern previously reported to the network device 120. Based on determining that the number of different beams is below a predefined maximum number, the terminal device 110 may transmit, via the transceiver to the network device 120, difference information between the first RS pattern and the second RS pattern. Based on determining that the number of different beams is above the predefined maximum number, the terminal device 110 may transmit, via the transceiver to the network device 120, the indication information directly indicative of the first RS pattern.

In some example embodiments, the terminal device 110 may, prior to determining whether to perform the beam set change, receive, via the transceiver from the network device 120, an indication that the beam set change is activated.

In some example embodiments, the configuration information may indicate one of the following: a first RS resource set associated with the first beam set, a second RS resource set associated with the second beam set, a first single value or a first value range for determining a number of beams in the second beam set, a second single value or a second value range for determining a number of measurement instances for the first beam set to be used for determining the second beam set, a threshold to be compared by the terminal device 110 with a difference in beam prediction performance between using the first beam set and using the second beam set to determine whether to perform the beam set change, a predefined maximum number of different beams, and at least one resource for transmitting the indication information.

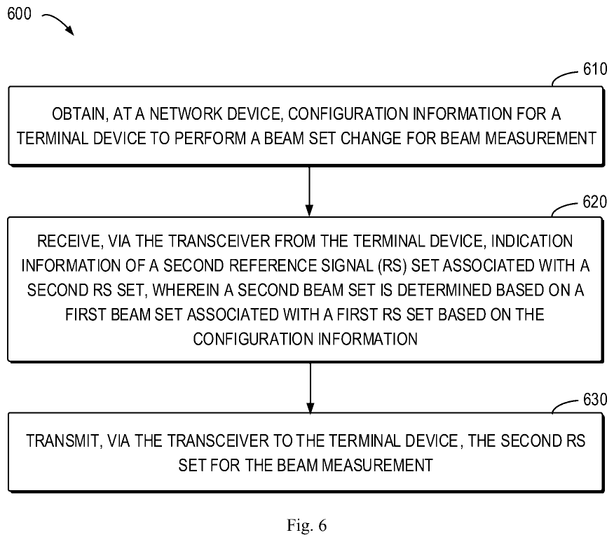

FIG. 6 illustrates another flowchart of an example method 600 for determining a beam set for beam measurement transmissions according to some other embodiments of the present disclosure. As shown in FIG. 6, at block 610, the network device 120 obtains configuration information for a terminal device 110 to perform a beam set change for beam measurement. At 620, the network device 120 receives, via the transceiver from the terminal device 110, indication information of a second reference signal (RS) set associated with a second RS set, wherein a second beam set is determined based on a first beam set associated with a first RS set based on the configuration information. At 630, the network device 120 transmits, via the transceiver to the terminal device 110, the second RS set for the beam measurement.

In some example embodiments, the second RS set may be a subset of the first RS set. In some example embodiments, a size of the second RS set may be less than a size of the first RS set.

In some example embodiments, the network device 120 may obtain the configuration information by one of the following: receiving, via the transceiver, the configuration information from the terminal device 110, or determining the configuration information at the network device 120.

In some example embodiments, the network device 120 may transmit, via the transceiver, the configuration information to the terminal device 110 after determining the configuration information at the network device 120.

In some example embodiments, the second beam set may be determined further based on historical measurement information associated with the first beam set. In some example embodiments, the second beam set may include a first number of beams in the first beam set, and RS received performance associated with the first number of beams may be better than RS received performance associated with other beams in the first beam set in a second number of measurement instances for the first beam set.

In some example embodiments, the second beam set may include a first number of beams with beam widths broader than beams in the first beam set, and a beam in second beam set may be related to at least one beam in the first beam set in a second number of measurement instances for the first beam set.

In some example embodiments, the first number may be determined based on a first single value or a first value range configured in the configuration information. In some example embodiments, the second number may be determined based on a second single value or a second value range configured in the configuration information.

In some example embodiments, the network device 120 may transmit the second RS set by: transmitting, via the transceiver to the terminal device 110, the first RS set and the second RS set in an interleaving manner.

In some example embodiments, a first set of period RS resource or semi-persistent RS resources with at least one of a first RS resource periodicity and a first offset may be configured by the network device 120 for the first beam set. In some example embodiments, a second set of period RS resource or semi-persistent RS resources with at least one of a second RS resource periodicity and a second offset may be configured by the network device 120 for the second beam set. In some example embodiments, the first RS resource periodicity may be greater than or equal to the second RS resource periodicity, and the first offset and the second offset may have a same or different value.

In some example embodiments, the first RS resource periodicity may be a multiple of the second RS resource periodicity. In some example embodiments, the network device 120 may transmit, via the transceiver to the terminal device 110, a time period for performing the beam measurement based on the second beam set. The network device 120 may start a timer with the time period when transmitting the second beam set to the terminal device 110. The network device 120 may transmit, via the transceiver, the first RS set to the terminal device 110 in case of expiry of the timer.

In some example embodiments, the network device 120 may, prior to transmitting the second RS set to the terminal device 110, receive, via the transceiver from the terminal device 110, a request for a set of aperiodic RS resources associated with the second RS set. The network device 120 may transmit, via the transceiver to the terminal device 110, downlink control information (DCI) indicative of the set of aperiodic RS resources.

In some example embodiments, the indication information may be reported from the terminal device 110 using one of: a channel state information reference signal resource indicator (CRI), a synchronization signal and physical broadcast channel block resource indicator (SSB-RI), or a bitmap.

In some example embodiments, the indication information may be indicative of difference information between a first RS pattern to be reported to the network device 120 and a second RS pattern previously reported to the network device 120.

In some example embodiments, the indication information may be indicative of difference information between a first RS pattern to be reported to the network device 120 and a second RS pattern previously reported to the network device 120.

In some example embodiments, the difference information may comprise a first indication indicative of at least one different beam between the first RS pattern and the second RS pattern through a bitmap, and a second indication indicative of at least one beam to replace the at least one different beam through at least one beam identifier.

In some example embodiments, a bit length of the second indication is determined based on one of the following: the least one different beam indicated by the first indication, or a configuration from the network device 120.

In some example embodiments, the difference information may comprise a first indication indicative of a number of different beams between the first RS pattern and the second RS pattern. The difference information may further comprise a second indication indicative of at least one different beam between the first RS pattern and the second RS pattern through at least one beam identifier. The difference information may further comprise a third indication indicative of at least one beam to replace the at least one different beam through at least one beam identifier.

In some example embodiments, a bit length of at least one of the second indication and the third indication may be determined based on one of the following: the number of different beams indicated by the first indication; or a configuration from the network device 120.

In some example embodiments, the difference information may comprise a second indication indicative of at least one different beam between the first RS pattern and the second RS pattern through at least one beam identifier. The difference information may further comprise a third indication indicative of at least one beam to replace the at least one different beam through at least one beam identifier. In some example embodiments, a bit length of at least one of the second indication and the third indication may be determined based on a configuration of a maximum number of different beams transmitted by the network device 120.

In some example embodiments, the network device 120 may receive the indication information of the second RS set by one of the following: receiving, via the transceiver from the terminal device 110, difference information between a first RS pattern to be reported to the network device 120 and a second RS pattern previously reported to the network device 120, and receiving, via the transceiver from the terminal device 110, the indication information directly indicative of the first RS pattern.

In some example embodiments, prior to receiving the indication information of the second RS set, the network device 120 may transmit, via the transceiver to the terminal device 110, an indication that the beam set change is activated.

In some example embodiments, the configuration information may indicate one of the following: a first RS resource set associated with the first beam set, a second RS resource set associated with the second beam set, a first single value or a first value range for determining a number of beams in the second beam set, a second single value or a second value range for determining a number of measurement instances for the first beam set to be used for determining the second beam set, a threshold to be compared by the terminal device 110 with a difference in beam prediction performance between using the first beam set and using the second beam set to determine whether to perform the beam set change, a predefined maximum number of different beams, and at least one resource for transmitting the indication information.

In this way, by implementing methods 500 and 600, a better performance in UE reporting overhead compared to traditional method can be achieved. For example, the RS overhead can be reduced and the beam prediction accuracy can be maintained.

### Example Apparatus

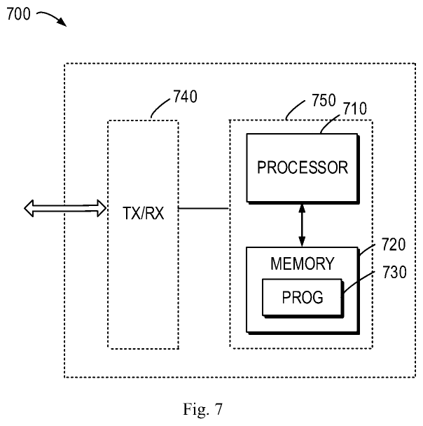

FIG. 7 illustrates a simplified block diagram of a device 700 that is suitable for implementing embodiments of the present disclosure. The device 700 can be considered as a further example implementation of the terminal device 110 or the network device 120 as shown in FIG. 1. Accordingly, the device 700 can be implemented at or as at least a part of the terminal device 110 or the network device 120.

As shown, the device 700 includes a processor 710, a memory 720 coupled to the processor 710, a suitable transmitter (TX) and receiver (RX) 740 coupled to the processor 710, and a communication interface coupled to the TX/RX 740. The memory 710 stores at least a part of a program 730. The TX/RX 740 is for bidirectional communications. The TX/RX 740 has at least one antenna to facilitate communication, though in practice an Access Node mentioned in this disclosure may have several ones. The communication interface may represent any interface that is necessary for communication with other network elements, such as X2 interface for bidirectional communications between eNBs or gNBs, S1 interface for communication between a Mobility Management Entity (MME)/Serving Gateway (S-GW) and the eNB or gNB, Un interface for communication between the eNB or gNB and a relay node (RN), or Uu interface for communication between the eNB or gNB and a terminal device.

The program 730 is assumed to include program instructions that, when executed by the associated processor 710, enable the device 700 to operate in accordance with the embodiments of the present disclosure, as discussed herein with reference to FIGS. 1-6. The embodiments herein may be implemented by computer software executable by the processor 710 of the device 700, or by hardware, or by a combination of software and hardware. The processor 710 may be configured to implement various embodiments of the present disclosure. Furthermore, a combination of the processor 710 and memory 720 may form processing means 750 adapted to implement various embodiments of the present disclosure.

The memory 720 may be of any type suitable to the local technical network and may be implemented using any suitable data storage technology, such as a non-transitory computer readable storage medium, semiconductor-based memory devices, magnetic memory devices and systems, optical memory devices and systems, fixed memory and removable memory, as non-limiting examples. While only one memory 720 is shown in the device 700, there may be several physically distinct memory modules in the device 700. The processor 710 may be of any type suitable to the local technical network, and may include one or more of general purpose computers, special purpose computers, microprocessors, digital signal processors (DSPs) and processors based on multicore processor architecture, as non-limiting examples. The device 700 may have multiple processors, such as an application specific integrated circuit chip that is slaved in time to a clock which synchronizes the main processor.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

1. A user equipment (UE) comprising:
at least one memory; and
at least one processor coupled with the at least one memory and configured to cause the UE to:
obtain configuration information for performing a beam set change for beam measurement;
determine, based on the configuration information, a second beam set associated with a second reference signal (RS) set based on a first beam set associated with a first RS set;
determine, based on the configuration information, whether to perform the beam set change;
based on determining to perform the beam set change, transmit indication information of the second RS set; and
perform the beam measurement based on the second RS set.

2. The UE of claim 1, wherein at least one of:
the second RS set is a subset of the first RS set; or
a size of the second RS set is less than a size of the first RS set.

3. (canceled)

4. (canceled)

5. The UE of claim 1, wherein the second beam set is determined further based on historical measurement information associated with the first beam set.

6. The UE of claim 5, wherein the second beam set includes a first number of beams in the first beam set, and RS received performance associated with the first number of beams is better than RS received performance associated with other beams in the first beam set in a second number of measurement instances for the first beam set.

7. (canceled)

8. The UE of claim 6, wherein at least one of the following:
the first number is determined based on a first single value or a first value range configured in the configuration information; or
the second number is determined based on a second single value or a second value range configured in the configuration information.

9. The UE of claim 1, wherein the at least one processor is configured to cause the UE to determine whether to perform the beam set change by:
determining whether a difference in beam prediction performance between using the first beam set and using the second beam set is below or above a threshold configured in the configuration information;
based on determining that the difference is below the threshold, determining to perform the beam set change; and
based on determining that the difference is above the threshold, determining not to perform the beam set change.

10. The UE of claim 9, wherein the difference in the beam prediction performance comprises one of the following:
a layer 1 reference signal received power (L1-RSRP) difference between at least one beam predicted using the first beam set and at least one beam predicted using the second beam set; or
a number or ratio of at least one same beam among at least one beam predicted using the first beam set and at least one beam predicted using the second beam set.

11. (canceled)

12. The UE claim 1, wherein the first RS set and the second RS set are transmitted in an interleaving manner.

13. (canceled)

14. (canceled)

15. (canceled)

16. (canceled)

17. (canceled)

18. The UE of claim 1, wherein the indication information is indicative of difference information between a first RS pattern to be reported to a network equipment (NE) and a second RS pattern previously reported to the NE.

19. (canceled)

20. (canceled)

21. (canceled)

22. (canceled)

23. (canceled)

24. (canceled)

25. (canceled)

26. (canceled)

27. A network equipment (NE) comprising:
at least one memory; and
at least one processor coupled with the at least one memory and configured to cause the NE to:
obtain configuration information for a user equipment (UE) to perform a beam set change for beam measurement;
receive indication information of a second reference signal (RS) set associated with a second RS set, wherein a second beam set is determined based on a first beam set associated with a first RS set based on the configuration information; and
transmit the second RS set for the beam measurement.

28. The NE of claim 27, wherein at least one of:
the second RS set is a subset of the first RS set; or
a size of the second RS set is less than a size of the first RS set.

29. (canceled)

30. (canceled)

31. The NE of claim 27, wherein the second beam set is determined further based on historical measurement information associated with the first beam set.

32. The NE of claim 31, wherein the second beam set includes a first number of beams in the first beam set, and RS received performance associated with the first number of beams is better than RS received performance associated with other beams in the first beam set in a second number of measurement instances for the first beam set.

33. (canceled)

34. (canceled)

35. The NE of claim 27, wherein the at least one processor is configured to cause the NE to transmit the second RS set by:
transmitting the first RS set and the second RS set in an interleaving manner.

36. (canceled)

37. (canceled)

38. (canceled)

39. (canceled)

40. (canceled)

41. (canceled)

42. (canceled)

43. (canceled)

44. (canceled)

45. (canceled)

46. (canceled)

47. (canceled)

48. (canceled)

49. (canceled)

50. A method of a user equipment (UE), comprising:
obtaining configuration information for performing a beam set change for beam measurement;
determining, based on the configuration information, a second beam set associated with a second reference signal (RS) set based on a first beam set associated with a first RS set;
determining, based on the configuration information, whether to perform the beam set change;
based on determining to perform the beam set change, transmitting indication information of the second RS set; and
performing the beam measurement based on the second RS set.

51. A method of a network equipment (NE) comprising:
obtaining configuration information for a user equipment (UE) to perform a beam set change for beam measurement;
receiving indication information of a second reference signal (RS) set associated with a second RS set, wherein a second beam set is determined based on a first beam set associated with a first RS set based on the configuration information; and
transmitting the second RS set for the beam measurement.

52. (canceled)

53. The method of claim 50, wherein determining the second beam set comprises selecting top-N beams from M most recent measurements of the first beam set.

54. The method of claim 50, wherein the indication information comprises difference information between a current RS pattern and a previously reported RS pattern, and the difference information includes at least one of:
a number of different beams;
a beam identifier for each different beam; and
a beam identifier for each replacement beam.

55. The method of claim 51, wherein receiving the indication information comprises receiving at least one of:
a bitmap indicating different beams between successive RS patterns; or
at least one beam identifier identifying updated beams.

56. The method of claim 51, wherein transmitting the second RS set comprises transmitting RS resources for the first beam set and the second beam set in an interleaving manner based on RS resource periodicities or offsets.
